(19) United States
(12) Patent Application Publication
(10) Pub. No.: US 2026/0349608 A1
(43) Pub. Date: Nov. 5, 2026

(54) INLINE ENCRYPTION SOLUTION FOR NONVOLATILE MEMORY EXPRESS (NVME) STORAGE DEVICES

(71) Applicant: QUALCOMM Incorporated, San Diego, CA (US)

(72) Inventors: Tanya MAHAJAN, Bangalore (IN); Amit GIL, Zichron Yaakov (IL); Kishalay HALDAR, Bangalore (IN); William KIMBERLY, San Diego, CA (US)

(21) Appl. No.: 19/125,528

(22) PCT Filed: Oct. 13, 2023
(86) PCT No.: PCT/US2023/035086

§ 371 Date: Apr. 29, 2025

(30) Foreign Application Priority Data
Nov. 9, 2022 (IN) 202241063945

(51) Int. Cl. G06F 3/06

(52) U.S. Cl. CPC G06F 3/0622; G06F 3/0655; G06F 3/0679

(57) ABSTRACT

Various embodiments include methods implemented in an inline cryptographic module of a nonvolatile memory express (NVMe) device. Embodiments may include storing data buffer addresses for NVMe commands and NVMe security identifiers for the NVMe commands in association with each other, in which the NVMe security identifiers include NVMe command submission queue identifiers and NVMe command identifiers for the NVMe commands, storing the NVMe security identifiers and security contexts for the NVMe commands in association with each other, retrieving a security context for an NVMe command based on an association of a data buffer address for the NVMe command with an NVMe security identifier of the NVMe command and an association of the NVMe security identifier with a security context for the NVMe command, and implementing a cryptographic function for data of the NVMe command using information of the security context for the NVMe command.

### RELATED APPLICATIONS

This application claims the benefit of priority from Indian Patent Application No. 202241063945, filed Nov. 9, 2022; the entire contents of which is herein incorporated by reference.

### BACKGROUND

The nonvolatile memory express (NVMe) protocol for solid state memory devices enables a fast and high throughput communication between an NVMe memory device and a system on chip (SoC). A peripheral component interface express (PCIe) controller may be configured to implement NVMe protocol communications between an NVMe device and components of an SoC. Data at the SoC for transmission to and transmitted from the NVMe device is vulnerable to manipulation by a malicious actor.

### SUMMARY

Various aspects include apparatuses and methods for implementing an inline cryptographic module of a system on chip (SoC) for a nonvolatile memory express (NVMe) device. Aspects may include storing data buffer addresses for NVMe commands and NVMe security identifiers for the NVMe commands in association with each other, in which the NVMe security identifiers include NVMe command submission queue identifiers and NVMe command identifiers for the NVMe commands, storing the NVMe security identifiers and security contexts for the NVMe commands in association with each other, retrieving a security context for an NVMe command based on an association of a data buffer address for the NVMe command with an NVMe security identifier of the NVMe command and an association of the NVMe security identifier with a security context for the NVMe command, and implementing a cryptographic function for data of the NVMe command using information of the security context for the NVMe command.

Some aspects further include configuring a structure for storing the data buffer addresses for the NVMe commands and the NVMe security identifiers for the NVMe commands in association with each other by an NVMe driver at the inline cryptographic module using information of the NVMe command, and configuring a structure for storing the NVMe security identifiers and the security contexts for the NVMe commands in association with each other by the NVMe driver at the inline cryptographic module using information of the NVMe command.

Some aspects further include receiving the NVMe command from an NVMe driver, configuring a structure for storing the data buffer addresses for the NVMe commands and the NVMe security identifiers for the NVMe commands in association with each other using information of the NVMe command, and configuring a structure for storing the NVMe security identifiers and the security contexts for the NVMe commands in association with each other using information of the NVMe command.

Some aspects further include updating an NVMe command submission queue tail pointer with a doorbell register address.

Some aspects further include generating a hash value for the NVMe command using information of the security context for the NVMe commands based on the association of the data buffer address for the NVMe command with the NVMe security identifier of the NVMe command and the association of the NVMe security identifier with the security context for the NVMe command, in which the hash value is for inclusion by an NVMe device in a device hint for the NVMe command.

Some aspects further include receiving a device hint for the NVMe command including a hash value of the NVMe command from an NVMe device, and configuring a structure for storing the data buffer addresses for the NVMe commands and the NVMe security identifiers for the NVMe commands in association with each other using information of the device hint for the NVMe command.

Some aspects further include validating the device hint for the NVMe command using the hash value, in which configuring the structure for storing the data buffer addresses for the NVMe commands and the NVMe security identifiers for the NVMe commands in association with each other using information of the device hint for the NVMe command may include configuring the structure for storing the data buffer addresses for the NVMe commands and the NVMe security identifiers for the NVMe commands in association with each other using information of the device hint for the NVMe command in response to determining that the device hint is valid.

Further aspects include computing devices including a plurality of processors configured to perform operations of any of the methods summarized above. Further aspects include computing devices having means for performing any of the functions of the methods summarized above. Further aspects include a power management integrated circuit configured to perform any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIG. 2 is a component block diagram illustrating an example inline cryptography nonvolatile memory express (NVMe) system suitable for implementing various embodiments.

FIG. 3 is a component block diagram illustrating an example inline cryptographic module for implementing various embodiments.

FIG. 4 is a process flow diagram illustrating a method of inline cryptography for NVMe devices according to some embodiments.

FIG. 5 is a process flow diagram illustrating a method of inline cryptography for NVMe devices with doorbell forwarding according to some embodiments.

FIG. 6 is a component block diagram illustrating an example inline cryptographic module including a hash module for implementing various embodiments.

FIGS. 7A and 7B are process flows diagram illustrating methods of inline cryptography for NVMe devices with device hint management according to some embodiments.

FIG. 8 is a component block diagram illustrating an example mobile computing device suitable for implementing various embodiments.

FIG. 9 is a component block diagram illustrating an example mobile computing device suitable for implementing various embodiments.

FIG. 10 is a component block diagram illustrating an example server suitable for implementing various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods, and computing devices implementing such methods, for implementing an inline cryptographic module of a system on chip (SoC) for a nonvolatile memory express (NVMe) device. In some embodiments the inline cryptographic module may be configured with an address lookup structure and a security context lookup structure by an NVMe driver implemented on the SoC. In some embodiments the inline cryptographic module may be enabled to configure itself with the address lookup structure and the security context lookup structure. These structures may be used together by the inline cryptographic module to identify a security context for an NVMe command to perform cryptographic functions, such as encrypting and/or decrypting, data of an NVMe transactions between the SoC and the NVMe device. In some embodiments the inline cryptographic module may be enabled to forward and indication of a pending NVMe command, such as a doorbell signal, to the NVMe device. In some embodiments the inline cryptographic module may be enabled to generate and validate hash values for device hints for NVMe transactions to evaluate integrity of the device hints for use in evaluating how to handle the NVMe transactions.

The terms “computing device” and “mobile device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

The NVMe protocol for memory devices enables a fast and high throughput communication between an NVMe memory device and an SoC. A peripheral component interface express (PCIe) controller may be configured to implement NVMe protocol communications between an NVMe device and components of an SoC. Data at the SoC for transmission to and transmitted from the NVMe device is vulnerable to manipulation by a malicious actor.

Various embodiments address and cure the foregoing problems of NVMe protocol communication by providing inline cryptographic functionality to secure the data at the SoC for transmission to and transmitted from the NVMe device. An inline cryptographic module may maintain information relating to NVMe commands and security contexts for those commands. The inline cryptographic module may implement cryptographic functions of encrypting data sent from an SoC to an NVMe device and/or decrypting data received at the SoC from the NVMe device using the information stored at the inline cryptographic module. For example, such information may include associations of identifying information for an NVMe transaction and an encryption algorithm and one or more encryption key holes, for retrieving one or more encryption keys from an encryption key storage structure. The inline cryptographic module may encrypt and/or decrypt the data of the NVMe transaction using the encryption algorithm and the one or more encryption keys accessible to the inline cryptographic module based on the information stored at the inline cryptographic module.

In some embodiments, further steps may be taken to secure the NVMe transactions by enabling the inline cryptographic module to generate and validate hash values for the NVMe transactions. The inline cryptographic module may generate a hash value for an NVMe transaction using information stored at the inline cryptographic module and provide it to an NVMe device to be returned in a device hint associated with an NVMe transaction. The hash value may be used to ensure that information sent to the NVMe device associated with a specific NVMe transaction has not changed when sent back in the device hint to the cryptographic module. The inline cryptographic module may generate another hash value using a combination of information from the device hint and the information stored at the inline cryptographic module. For example, such information stored at the inline cryptographic module may include associations of identifying information for an NVMe transaction and a hash algorithm and one or more hash key holes, for retrieving one or more hash keys from a hash key storage structure. The inline cryptographic module may generate the hashes using the hash algorithm and the one or more hash keys accessible to the inline cryptographic module based on the information stored at the inline cryptographic module. The hashes may be included in device hints for NVMe transactions. The inline cryptographic module may compare the hashes to evaluate the integrity of the device hints, based on whether the hashes match, for evaluating how to handle the NVMe transactions.

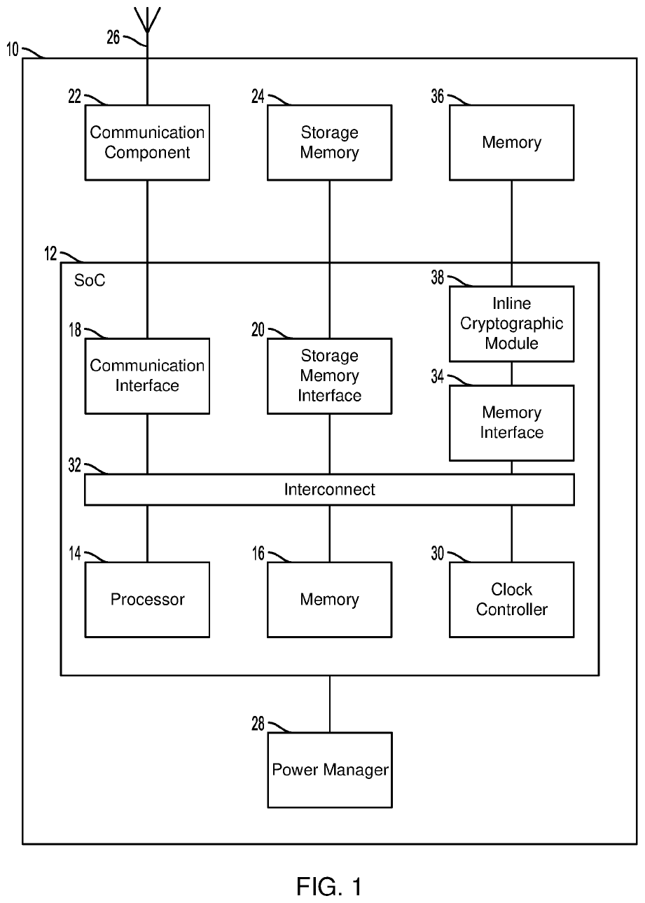

FIG. 1 illustrates a system including a computing device 10 suitable for use with various embodiments. The computing device 10 may include a system-on-chip (SoC) 12 with a processor 14, a memory 16, a memory interface 34, an inline cryptographic module 38, a communication interface 18, a storage memory interface 20, a clock controller 30, and an interconnect 32. The computing device 10 may further include a communication component 22, such as a wired or wireless modem, a storage memory 24, an antenna 26 for establishing a wireless communication link, a power manager 28, and a memory 36. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), a secure processing unit (SPU), neural network processing unit (NPU), a subsystem processor of specific components of the computing device, such as an image processor for a camera subsystem or a display processor for a display, an auxiliary processor, a single-core processor, a multicore processor, a controller, and a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

An SoC 12 may include one or more processors 14. The computing device 10 may include more than one SoC 12, thereby increasing the number of processors 14 and processor cores. The computing device 10 may also include processors 14 that are not associated with an SoC 12. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The computing device 10 may include any number and combination of memories, such as the memory 16 integral to the SoC 12 and the memory 36 separate from the SoC 12. Any of the memories 16, 36 may be a volatile or non-volatile memory configured for storing data and processor-executable code for access by the processor 14. The computing device 10 and/or SoC 12 may include one or more memories 16, 36 configured for various purposes. One or more memories 16, 36 may include volatile memories such as random access memory (RAM) or main memory, including static RAM (SRAM), such as the memory 16, dynamic RAM (DRAM), such as the memory 36, or cache memory.

The memories 16, 36 may be configured to temporarily store a limited amount of data. For example, the data may be received from a data sensor or subsystem. As another example, the data may be data and/or processor-executable code instructions that are requested from a non-volatile memory 16, 24, 36 loaded to the memories 16, 36 from the non-volatile memory 16, 24, 36 in anticipation of future access based on a variety of factors. As another example, the data may be intermediary processing data and/or processor-executable code instructions produced by the processor 14 and temporarily stored for future quick access without being stored in non-volatile memory 16, 24, 36.

The memory interface 34 may work in unison with the memory 36 to enable the computing device 10 to store and retrieve data and processor-executable code on and from the memory 36. The memory interface 34 may control access to the storage memory 36 and allow the processor 14 to read data from and write data to the memory 36.

The storage memory interface 20 and the storage memory 24 may work in unison to allow the computing device 10 to store data and processor-executable code on a non-volatile storage medium, such as a nonvolatile memory express (NVMe) memory device. The storage memory 24 may be configured much like an embodiment of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

The inline cryptographic module 38 may be configured to implement cryptographic functions, such as encryption and decryption, of data for transactions of the memory storage device 24. Data transmitted between the memory 36 and the storage memory 24 may be encrypted and decrypted by the inline cryptographic module 38 to secure the data stored and the memory storage device 24 by encrypting the data, and make usable, by the SoC, the encrypted data retrieved from the memory storage device 24 by decrypting the data. The inline cryptographic module 38 may be configured to implement hash generation and validation for device hints related to the data transmitted between the memory 36 and the storage memory 24 to assess integrity of the device hints for use in evaluating whether to use the data.

The power manager 28 may be configured to control power states of one or more power rails (not shown) for power delivery to the components of the SoC 12. In some embodiments, the power manager 28 may be configured to control amounts of power provided to the components of the SoC 12. For example, the power manager 28 may be configured to control connections between components of the SoC 12 and the power rails. As another example, the power manager 28 may be configured to control amounts of power on the power rails connected to the components of the SoC 12. The power manager 28 may be configured as a power management integrated circuit (power management ICs or PMIC).

A clock controller 30 may be configured to control clock signals transmitted to the components of the SoC 12. For example, the clock controller 30 may gate a component of the SoC 12 by disconnecting the component of the SoC 12 from a clock signal and may ungate the component of the SoC 12 by connecting the component of the SoC 12 to the clock signal.

The interconnect 32 may be a communication fabric, such as a communication bus, configured to communicatively connect the components of the SoC 12. The interconnect 32 may transmit signals between the components of the SoC 12. In some embodiments, the interconnect 32 may be configured to control signals between the components of the SoC 12 by controlling timing and/or transmission paths of the signals.

Some or all of the components of the computing device 10 and/or the SoC 12 may be arranged differently and/or combined while still serving the functions of the various embodiments. The computing device 10 may not be limited to one of each of the components, and multiple instances of each component may be included in various configurations of the computing device 10.

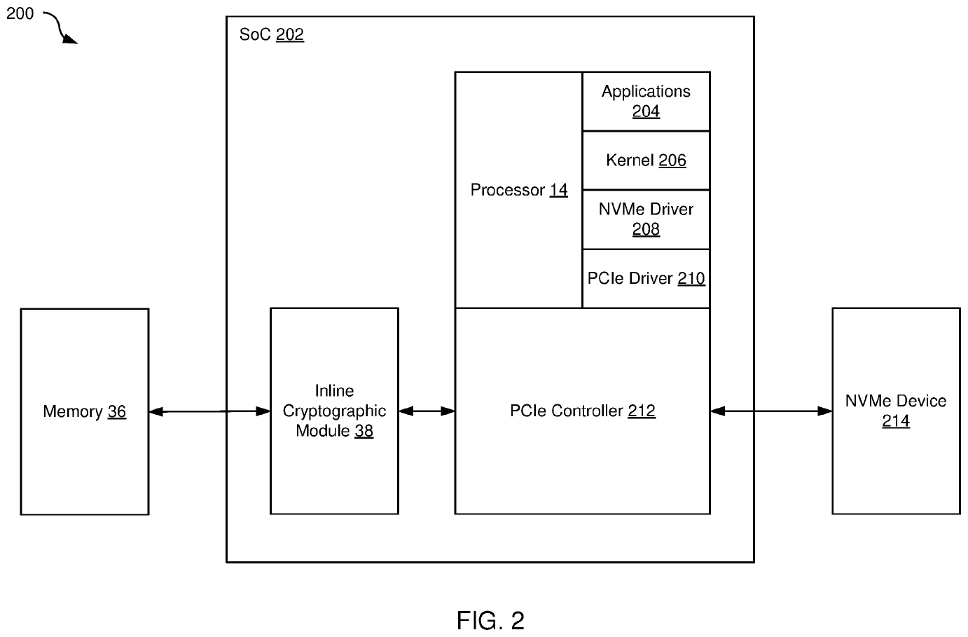

FIG. 2 illustrates an example of an inline cryptography NVMe system 200 suitable for implementing various embodiments. With reference to FIGS. 1 and 2, the inline cryptography NVMe system 200 may be implemented in a computing device (e.g., computing device 10 in FIG. 1), include the memory 36, an SoC 202 (e.g., SoC 12 in FIG. 1), and an NVMe device 214 (or NVMe memory device) (e.g., storage memory 24 in FIG. 1) connected to each other by various communication buses.

The SoC 202 may include a processor 14, peripheral component interface express (PCIe) controller 212 (e.g., storage memory interface 20 in FIG. 1), and an inline cryptographic module 38 connected to each other by various communication buses. The processor 14 may be configured to implement software, such as applications 204, including a high-level operating system, a kernel 206, an NVMe driver 208, and a PCIe driver 210. The PCIe controller 212 may manage communication between components of the SoC 202, including the inline cryptographic module 38, and the NVMe device 214. Such communications may include communications for preparation and implementation of NVMe commands from the processor 14 for data transactions, such as read and/or write transactions, at the NVMe device 214.

The inline cryptographic module 38 may be a hardware module integral to the SoC 202. The inline cryptographic module 38 may implement cryptographic functions, such as encrypting, decrypting, and/or bypassing, for data of the NVMe commands. For example, the inline cryptographic module 38 may encrypt data sent to the NVMe device 214 and decrypt data received from the NVMe device 214. The cryptographic functions implemented by the inline cryptographic module 38 may be of any known, proprietary, and/or to be developed encryption and decryption means. For example, the inline cryptographic module 38 may provide per application and/or file-based cryptographic functions. A software running on the SoC 202, the NVMe driver 208, and/or the application 204, may issue a request to use a specific algorithm for encryption and a set of encryption keys, use a specific security context, and/or ask to send data without encryption. Setting the security context, encryption keys, and/or encryption algorithm may be implemented by any of the software running on the SoC 202, the NVMe driver 208, and/or the application 204 while using a security context, encryption keys, and/or an encryption algorithm to encrypt or decrypt the data can be done by another software entity. The inline cryptographic module 38 may also support secure key management. In some examples, the inline cryptographic module 38 may function independently of PCIe structures and its different layers, enable scalable storage throughput, and be compliant with NVMe device protocols. In other examples, the inline cryptographic module 38 may be part of the PCIe controller 212. The inline cryptographic module 38 is described further herein.

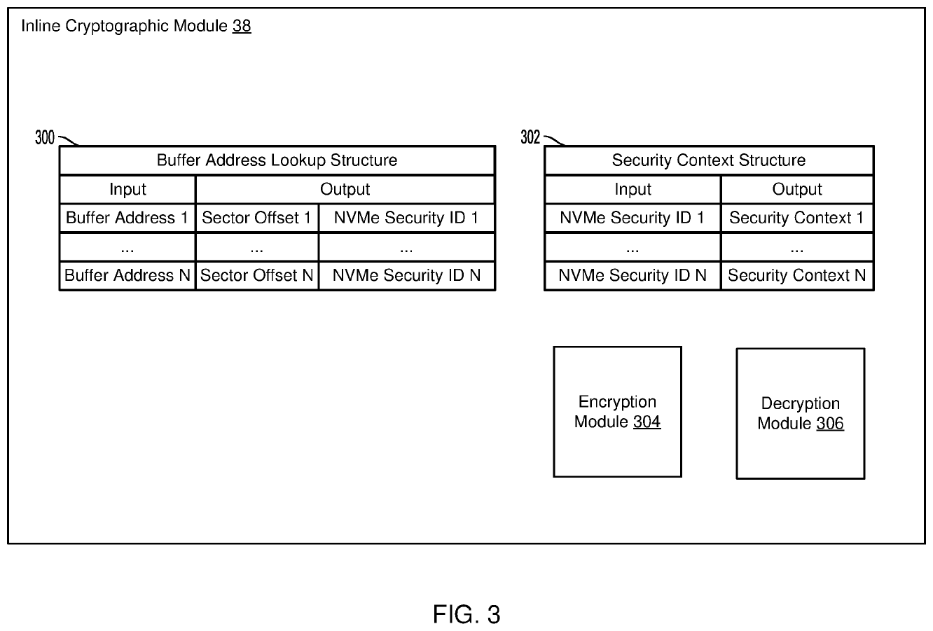

FIG. 3 illustrates an example of the inline cryptographic module 38 for implementing various embodiments. With reference to FIGS. 1-3, the inline cryptographic module 38 may be configured with a buffer address lookup structure 300, a security context structure 302, an encryption module 304 and a decryption module 306. The encryption module 304 and the decryption module 306 are described herein as separate components for ease of explanation and clarity consistent with a nonlimiting embodiment. However, such separate descriptions are not intended to limit the scope of the claims and specification and in some implementations and embodiments, the encryption module 304 and the decryption module 306 may be implemented as a single combined module.

The buffer address lookup structure 300 may be a data structure, such as a table, array, linked list, graph, etc., configured to store various data in association with each other. For example, the buffer address lookup structure 300 may store data of at least a buffer address of the memory 36, referred to herein as buffer address, and an NVMe security identifier (ID) for an NVMe command in association with each other. The buffer address may be used for the NVMe command to write out data from the buffer address of the memory 36 to the NVMe device 214 and/or to read in data from the NVMe device 214 to the buffer address of the memory 36. The NVMe security ID may be a combination of data, such as an NVMe command submission queue identifier and an NVMe command identifier for the NVMe command. The NVMe command submission queue identifier may identify an NVMe command submission queue to which the NVMe driver 208 may write the NVMe command. The NVMe command submission queue may trigger a doorbell signal configured to indicate to the NVMe device 214 that the NVMe command in the NVMe command submission queue is ready for execution when the NVMe command reaches an end of the NVMe command submission queue. The NVMe command ID may identify the NVMe command. The buffer address lookup structure 300 may also store data of a sector offset for the NVMe command in association with the buffer address and the NVMe security ID. The sector offset may be used in generation of an initialization vector for a cryptographic function. The initialization vector may be used as input to an encryption algorithm and be configured to affect encryption of data in a manner in which the data encrypted multiple times may result in different encrypted values. The buffer address lookup structure 300 may store any amount of associated data, such as more than one set of associated data for more than one NVMe command.

The security context structure 302 may be a data structure, such as a table, array, linked list, graph, etc., configured to store various data in association with each other. For example, the security context structure 302 may store data of the NVMe security ID and a security context for the NVMe command in association with each other. The NVMe security ID in the buffer address lookup structure 300 and the security context structure 302 for the same NVMe command may be the same. The security context may include a combination of security related information, such as an encryption algorithm, one or more encryption key slots for retrieving one or more encryption keys from an encryption key storage structure, etc. In some examples, the security context may be provided by an application executed by the processor 14 from the execution of which the NVMe command originates. The security context structure 302 may store any amount of associated data, such as more than one set of associated data for more than one NVMe command.

The buffer address lookup structure 300 and the security context structure 302 may be configured at the inline cryptographic module 38 during an NVMe command submission stage. In some examples, the NVMe driver (e.g., NVMe driver 208 in FIG. 2) may configure the buffer address lookup structure 300 and the security context structure 302 at the inline cryptographic module 38 in response to receiving an NVMe command issued by a processor (e.g., processor 14). The NVMe driver may provide the inline cryptographic module 38 with the data for populating the buffer address lookup structure 300 and the security context structure 302, and the inline cryptographic module 38 may store the data as the buffer address lookup structure 300 and the security context structure 302. Such data may include any combination of buffer addresses, NVMe security IDs, sector offsets, and/or security contexts for NVMe commands. In such examples, the NVMe driver may maintain the same address information at two different locations, an SoC memory (e.g., memory 16, 36 in FIG. 1) and at the buffer address lookup structure 300.

In some examples, the inline cryptographic module 38 may configure the buffer address lookup structure 300 and the security context structure 302 at the inline cryptographic module 38 in response to receiving an NVMe command from the NVMe driver. The inline cryptographic module 38 may process the NVMe command, extracting the data for populating the buffer address lookup structure 300 and the security context structure 302, and the inline cryptographic module 38 may store the data as the buffer address lookup structure 300 and the security context structure 302. The inline cryptographic module 38 configuring the buffer address lookup structure 300 and the security context structure 302, rather than the NVMe driver, eliminates the previously described address redundancy issue and maintains data integrity.

Further, overhead on software to configure the buffer address lookup structure 300 in the inline cryptographic module 38 is reduced.

The inline cryptographic module 38 may be configured to forward a doorbell signal configured to indicate to an NVMe device (e.g., storage memory 24 in FIG. 1, NVMe device 214 in FIG. 2) of a pending NVMe command. For example, the inline cryptographic module 38 may update an NVMe command submission queue tail point to a “doorbell” register of the NVMe device. Forwarding the doorbell signal may enable bypassing or foregoing inclusion of software configured to write two doorbells, as per known implementations of the NVMe protocol, and may ensure that the operation of the cryptographic module 38 and the NVMe device are synchronized.

In response to receiving an NVMe transaction from the NVMe device, the inline cryptographic module 38 may use information from the NVMe transaction to implement a cryptographic function for the data of the NVMe transaction. For example, the inline cryptographic module 38 may retrieve a buffer address from the NVMe transaction and use the buffer address to retrieve the associated data, such as the NVMe security ID, from the buffer address lookup structure 300. In some examples, the inline cryptographic module 38 may use the buffer address to retrieve the associated sector offset from the buffer address lookup structure 300. The inline cryptographic module 38 may use the retrieved NVMe security ID to retrieve the associated security context for the NVMe command from the security context structure 302.

Using the retrieved information, such as the sector offset and/or the security context, the encryption module 304 and/or the decryption module 306 may implement the cryptographic function for the data of the NVMe transaction. For example, the retrieved information may include the security context from the security context structure 302, which may include an encryption algorithm, one or more encryption key slots for retrieving one or more encryption keys from an encryption key storage structure, etc. The encryption module 304 may use the retrieved information of the security context to encrypt the data to be sent to the NVMe device for the NVMe transaction. The decryption module 306 may use the retrieved information of the security context to decrypt the data received from the NVMe device for the NVMe transaction.

As another example, the retrieved information may include the sector offset from the buffer address lookup structure 300. The encryption module 304 may use the retrieved sector offset to generate an initialization vector, and use the initialization vector with the retrieved information of the security context to encrypt the data to be sent to the NVMe device for the NVMe transaction. The decryption module 306 may use the retrieved sector offset to generate an initialization vector, and use the initialization vector with the information of the retrieved information of the security context to decrypt the data received from the NVMe device for the NVMe transaction. The encryption module 304 may input unencrypted data for the NVMe command, one or more encryption keys, and/or an initialization vector to an encryption algorithm and generate encrypted data for the NVMe command. The decryption module 306 may input encrypted data for the NVMe command, one or more encryption keys, and/or an initialization vector to an encryption algorithm and generate decrypted data for the NVMe command.

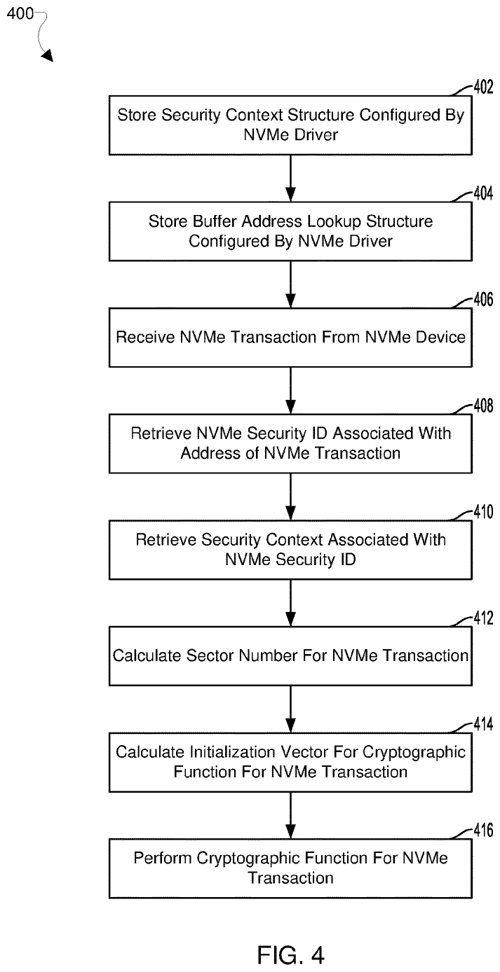

FIG. 4 illustrates a method for method of inline cryptography for NVMe devices according to some embodiments. With reference to FIGS. 1-4, the method 400 may be implemented in a computing device (e.g., computing device 10 in FIG. 1), in software executing in a processor (e.g., processor 14 in FIGS. 1 and 2, inline cryptographic module 38 in FIGS. 1-3), in general purpose hardware, in dedicated hardware (e.g., inline cryptographic module 38 in FIGS. 1-3, encryption module 304, decryption module 306 in FIG. 3), or in a combination of a software-configured processor and dedicated hardware, such as a processor executing software within a power management system (e.g., inline cryptography NVMe system 200 in FIG. 2) that includes other individual components, and various memory/cache controllers. In order to encompass the alternative configurations enabled in various embodiments, the hardware implementing the method 400 is referred to herein as an “inline cryptographic device.” Means for implementing the method 400 may include a processor (e.g., 14, 38, 304, 306).

In block 402, an inline cryptographic device may store a security context structure (e.g., security context structure 302 in FIG. 3) configured by the NVMe driver (e.g., NVMe driver 208 in FIG. 2). The inline cryptographic device may receive data for populating the security context structure from the NVMe driver and store the data as the security context structure. The inline cryptographic device may store various data in association with each other in the security context structure. For example, the security context structure may store data of an NVMe security ID for an NVMe command and a security context for the NVMe command in association with each other. The NVMe security ID may be a combination of data, such as an NVMe command submission queue identifier and an NVMe command identifier for the NVMe command. The security context may include a combination of security related information, such an encryption algorithm, one or more key slots, etc. In some examples, the security context may be provided by an application executed by a processor (e.g., processor 14 in FIGS. 1 and 2) from the execution of which the NVMe command originates. In some examples, the inline cryptographic device storing the security context structure configured by the NVMe driver in block 402 may include an inline cryptographic module (e.g., inline cryptographic module 38 in FIGS. 1-3).

In block 404, the inline cryptographic device may store a buffer address lookup structure (e.g., buffer address lookup structure 300 in FIG. 3) configured by the NVMe driver. The inline cryptographic device may receive data for populating the buffer address lookup structure from the NVMe driver and store the data as the buffer address lookup structure. The inline cryptographic device may store various data in association with each other in the buffer address lookup structure. For example, the buffer address lookup structure may store data of at least a buffer address and the NVMe security ID for the NVMe command in association with each other.

The NVMe security ID in the buffer address lookup structure and the security context structure for the same NVMe command may be equivalent. The buffer address lookup structure may also store data of a sector offset for the NVMe command in association with the buffer address and the NVMe security ID. The sector offset may be used in generation of an initialization vector for a cryptographic function. In some examples, the inline cryptographic device storing the buffer address lookup structure configured by the NVMe driver in block 404 may include the inline cryptographic module.

In block 406, the inline cryptographic device may receive an NVMe transaction from an NVMe device (e.g., storage memory 24 in FIG. 1, NVMe device 214 in FIG. 2). The NVMe transaction may be an implementation of an NVMe command by the NVMe device, such as a read and/or write transaction. The NVMe transaction may be received by inline cryptographic device from the NVMe device via a device interface (e.g., storage memory interface 20 in FIG. 1, PCIe controller 212 in FIG. 2). The NVMe transaction may include information for implementing the NVMe transaction, such as a buffer address, and/or data for implementing the NVMe transaction, such as read and/or write data. The data of a read transaction may be encrypted when received by the inline cryptographic device. The data of a write transaction may be encrypted by the inline cryptographic device before sending to the NVMe device. In some examples, the inline cryptographic device receiving the NVMe transaction from the NVMe device in block 406 may include the inline cryptographic module.

In block 408, the inline cryptographic device may retrieve an NVMe security ID associated with a buffer address for the NVMe transaction. The inline cryptographic device may retrieve the buffer address from the NVMe transaction and use the buffer address to retrieve the associated data, such as the NVMe security ID and/or a sector offset, from the buffer address lookup structure. In some examples, the inline cryptographic device retrieving the NVMe security ID associated with the buffer address for the NVMe transaction in block 408 may include the inline cryptographic module.

In block 410, the inline cryptographic device may retrieve a security context associated with the NVMe security ID. The inline cryptographic device may use the retrieved NVMe security ID to retrieve the associated security context for the NVMe command from the security context structure. some examples, the inline cryptographic device retrieving the security context associated with the NVMe security ID in block 410 may include the inline cryptographic module.

In block 412, the inline cryptographic device may calculate a sector number for implementing the NVMe transaction. The inline cryptographic device may use the buffer address of the NVMe transaction, and the retrieved associated sector offset from the buffer address lookup structure to calculate the sector number by known means. In some examples, the inline cryptographic device calculating the sector number for implementing the NVMe transaction in block 412 may include the inline cryptographic module.

In block 414, the inline cryptographic device may calculate an initialization vector for a cryptographic function for implementing the NVMe transaction. The inline cryptographic device may use sector number to calculate the initialization vector by known means. In some examples, the inline cryptographic device calculating the initialization vector for the cryptographic function for implementing the NVMe transaction in block 414 may include the inline cryptographic module.

In block 416, the inline cryptographic device may perform the cryptographic function for implementing the NVMe transaction. Using the retrieved and calculated information, such as the security context and the initialization vector, the inline cryptographic device may implement the cryptographic function for the data of the NVMe transaction. For example, the inline cryptographic device may encrypt the data to be sent to the NVMe device for the NVMe transaction. As another example, the inline cryptographic device may decrypt the data received from the NVMe device for the NVMe transaction. In some examples, the inline cryptographic device performing the cryptographic function for implementing the NVMe transaction in block 416 may include the inline cryptographic module, an encryption module (e.g., encryption module 304 in FIG. 3), and/or a decryption module (e.g., decryption module 306 in FIG. 3).

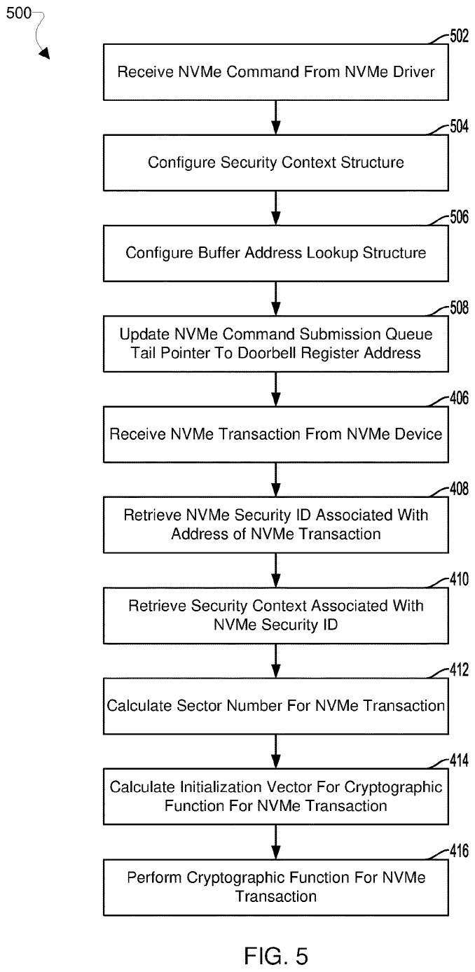

FIG. 5 illustrates a method of inline cryptography for NVMe devices with doorbell forwarding according to some embodiments. With reference to FIGS. 1-5, the method 500 may be implemented in a computing device (e.g., computing device 10 in FIG. 1), in software executing in a processor (e.g., processor 14 in FIGS. 1 and 2, inline cryptographic module 38 in FIGS. 1-3), in general purpose hardware, in dedicated hardware (e.g., inline cryptographic module 38 in FIGS. 1-3, encryption module 304, decryption module 306 in FIG. 3), or in a combination of a software-configured processor and dedicated hardware, such as a processor executing software within a power management system (e.g., inline cryptography NVMe system 200 in FIG. 2) that includes other individual components, and various memory/cache controllers. In order to encompass the alternative configurations enabled in various embodiments, the hardware implementing the method 500 is referred to herein as an “inline cryptographic device.” Means for implementing the method 500 may include a processor (e.g., 14, 38, 304, 306).

In block 502, the inline cryptographic device may receive an NVMe command from an NVMe driver (e.g., NVMe driver 208 in FIG. 2). A processor (e.g., processor 14 in FIGS. 1 and 2) may execute an application from which the NVMe command originates and is sent to the NVMe driver. The NVMe driver may submit the NVMe command by updating an NVMe command submission queue. The NVMe driver may also forward the NVMe command to the inline cryptographic device. In some examples, the inline cryptographic device receiving the NVMe command from the NVMe driver in block 502 may include an inline cryptographic module (e.g., inline cryptographic module 38 in FIGS. 1-3).

In block 504, the inline cryptographic device may configure a security context structure (e.g., security context structure 302 in FIG. 2) at the inline cryptographic device. The inline cryptographic device may process the NVMe command, extracting the data for populating the security context structure, and the inline cryptographic device may store the data as the security context structure. The inline cryptographic device may store various data in association with each other in the security context structure. For example, the security context structure may store data of an NVMe security ID and a security context for the NVMe command in association with each other. The NVMe security ID may be a combination of data, such as an NVMe command submission queue identifier and an NVMe command identifier for the NVMe command. The security context may include a combination of security related information, such an encryption algorithm, one or more key slots, etc. In some examples, the security context may be provided by the application executed by the processor from the execution of which the NVMe command originates. In some examples, the inline cryptographic device configuring the security context structure at the inline cryptographic device in block 504 may include the inline cryptographic module.

In block 506, the inline cryptographic device may configure a buffer address lookup structure (e.g., buffer address lookup structure 300 in FIG. 2) at the inline cryptographic device. The inline cryptographic device may process the NVMe command, extracting the data for populating the buffer address lookup structure, and the inline cryptographic device may store the data as the buffer address lookup structure. The inline cryptographic device may store various data in association with each other in the buffer address lookup structure. For example, the buffer address lookup structure may store data of at least a buffer address and the NVMe security ID for the NVMe command in association with each other. The NVMe security ID in the buffer address lookup structure and the security context structure for the same NVMe command may be equivalent. The buffer address lookup structure may also store data of a sector offset for the NVMe command in association with the buffer address and the NVMe security ID. The sector offset may be used in generation of an initialization vector for a cryptographic function. In some examples, the inline cryptographic device configuring the buffer address lookup structure at the inline cryptographic device in block 506 may include the inline cryptographic module.

In block 508, the inline cryptographic device may update an NVMe command submission queue tail pointer to a doorbell register address. The inline cryptographic device may be configured to forward a doorbell signal configured to indicate to an NVMe device (e.g., storage memory 24 in FIG. 1, NVMe device 214 in FIG. 2) of a pending NVMe command. The inline cryptographic device may update the NVMe command submission queue tail point to the doorbell register of the NVMe device. In some examples, the inline cryptographic device updating the NVMe command submission queue tail pointer to the doorbell register address in block 508 may include the inline cryptographic module.

The inline cryptographic device may implement blocks 406-416 similarly as described herein for the same numbered blocks of the method 400 with reference to FIG. 4. In some examples, the inline cryptographic device implementing blocks 406-416 may include the inline cryptographic module, an encryption module (e.g., encryption module 304 in FIG. 3), and/or a decryption module (e.g., decryption module 306 in FIG. 3).

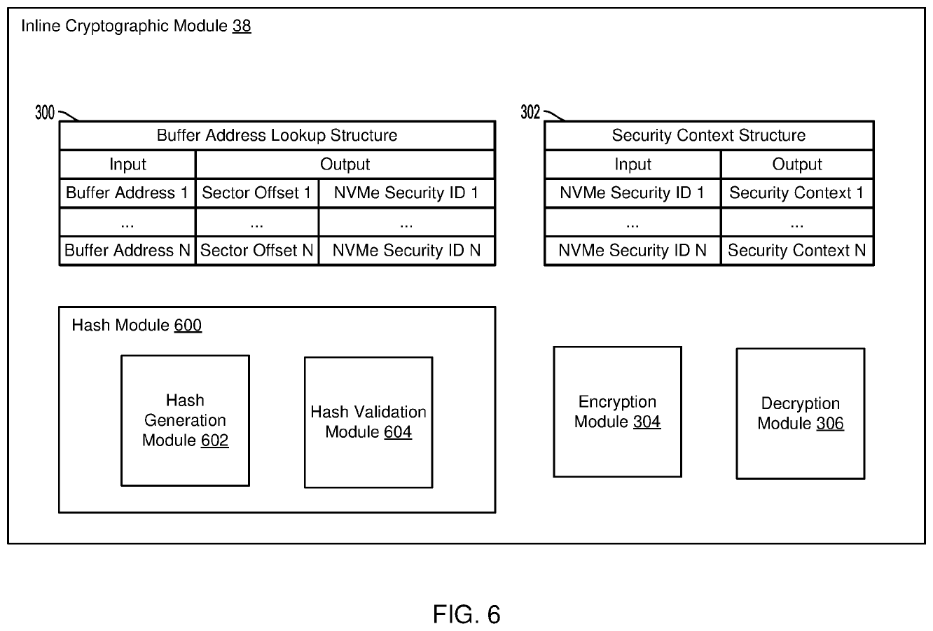

FIG. 6 illustrates an example of the inline cryptographic module 38 for implementing various embodiments. With reference to FIGS. 1-6, the inline cryptographic module 38 may be configured with the buffer address lookup structure 300, the security context structure 302, the encryption module 304 and the decryption module 306 as described herein for the same numbered items of the inline cryptographic module 38 with reference to FIG. 3. The inline cryptographic module 38 may be further configured with a hash module 600, which the inline cryptographic module 38 may use to evaluate integrity of device hints for evaluating how to handle NVMe transactions.

The hash module 600 may include a hash generation module 602 and a hash validation module 604. The hash generation module 602 may be configured to generate hash values for each buffer address for NVMe commands. The hash values may sign the buffer addresses where data to read or write is located in local SoC memory (e.g., memory 16, 36 in FIGS. 1 and 2). The hash generation module 602 may receive information from the NVMe driver (e.g., NVMe driver 208 in FIG. 2) and retrieve security context information from the security context structure 302 to generate a hash value for a buffer address. The information received from the NVMe driver may be for an NVMe command submitted to the NVMe command submission queue, and may include the buffer address, the NVMe security ID, the sector offset, a cookie, predefined text or data, and/or other information that may help in processing a device hint, as described further herein. The information retrieved from the security context structure 302 may be information associated with the NVMe security ID received from the NVMe driver, and may include a hash algorithm, one or more hash key slots for retrieving one or more hash keys from a hash key storage structure, etc. The hash generation module 602 may use the hash algorithm with the one or more hash keys, retrieved using the one or more hash key slots, to generate a hash value of the buffer address, the NVMe security ID, the sector offset, the cookie, the predefined text or data, and/or the other information that may help in processing the device hint. The hash value may be provided to an NVMe device (e.g., NVMe device 214 in FIG. 2), such as via a device interface (e.g., storage memory interface 20 in FIG. 1, PCIe controller 212 in FIG. 2), for inclusion in a device hint to be sent back to the inline cryptographic module 38 for an NVMe transaction. The hash may be used to ensure integrity of the device hint for when the NVMe device sends the device hint to the SoC (e.g., SoC 12, 202 in FIGS. 1 and 2) with an NVMe transaction.

The generation module 602 may receive device hint information from the NVMe device for an NVMe transaction, such as via the device interface, and retrieve security context information from the security context structure 302 to generate a hash value for the device hint of the NVMe transaction. The information from the device hint may include the NVMe security ID, the buffer address, the sector offset, the cookie, the predefined text or data, and/or the other information that may help in processing the device hint. The information retrieved from the security context structure 302 may be information associated with the NVMe security ID received from the NVMe driver, and may include the hash algorithm, the one or more hash key slots for retrieving the one or more hash keys from the hash key storage structure, etc. The hash generation module 602 may use the hash algorithm with the one or more hash keys, retrieved using the one or more hash key slots, to generate a hash value of the buffer address, the NVMe security ID, and the sector offset.

The hash validation module 604 may be configured to compare hash values from the device hint and generated from information of the device hint to evaluate integrity of the device hint for the NVMe transactions. The hash validation module 604 may retrieve the hash value from the device hint and receive the hash value generated from information of the device hint from the hash generation module 602 and compare the hash values. The hash validation module 604 may determine that the device hint is not corrupted in response to the hash values matching and that the device hint is corrupted in response to the hash values not matching. Whether the device hint is corrupted may likewise be indicative of whether the data of the NVMe transaction associated with the device hint is corrupted.

The inline cryptographic module 38 may configure the buffer address lookup structure 300 with information from the device hint in response to the hash validation module 604 determining that the NVMe transaction associated with the device hint is not corrupted. The inline cryptographic module 38 may process the device hint, extracting the data for populating the buffer address lookup structure 300 and the inline cryptographic module 38 may store the data as the buffer address lookup structure 300. The inline cryptographic module 38 configuring the buffer address lookup structure 300 in response to validation of the hash of the device hint reduces the size, and thereby the resources for maintaining the buffer address lookup structure 300 by the inline cryptographic module 38 and increases security of the NVMe transactions.

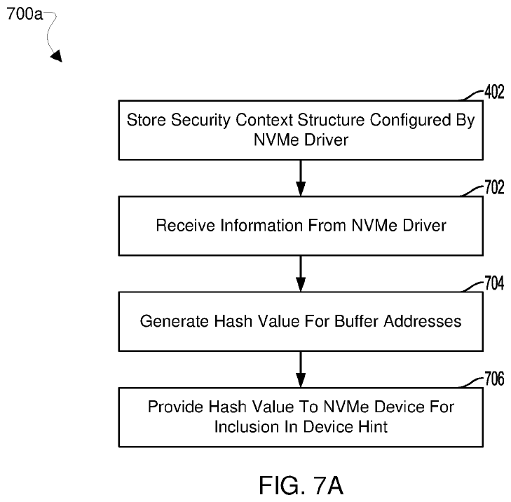

FIGS. 7A and 7B illustrate a method for method of inline cryptography for NVMe devices with device hint management according to some embodiments. With reference to FIGS. 1-7B, the methods 700a, 700b may be implemented in a computing device (e.g., computing device 10 in FIG. 1), in software executing in a processor (e.g., processor 14 in FIGS. 1 and 2, inline cryptographic module 38 in FIGS. 1-3), in general purpose hardware, in dedicated hardware (e.g., inline cryptographic module 38 in FIGS. 1-3, encryption module 304, decryption module 306 in FIG. 3, hash module 600, hash generation module 602, hash validation module 604 in FIG. 6), or in a combination of a software-configured processor and dedicated hardware, such as a processor executing software within a power management system (e.g., inline cryptography NVMe system 200 in FIG. 2) that includes other individual components, and various memory/cache controllers. In order to encompass the alternative configurations enabled in various embodiments, the hardware implementing the methods 700a, 700b is referred to herein as an “inline cryptographic device.” Means for implementing the methods 700a, 700b may include a processor (e.g., 14, 38, 304, 306, 600, 602, 604).

For the method 700a, the inline cryptographic device may implement block 402 similarly as described herein for the same numbered block of the method 400 with reference to FIG. 4. In some examples, the inline cryptographic device implementing block 402 may include an inline cryptographic module (e.g., inline cryptographic module 38 in FIGS. 1-3 and 6).

In block 702, the inline cryptographic device may receive information from an NVMe driver (e.g., NVMe driver 208 in FIG. 2). The information received from the NVMe driver may be for one or more NVMe commands submitted to the NVMe command submission queue, and may include the buffer addresses, the NVMe security IDs, and the sector offsets. In some examples, the inline cryptographic device receiving the information from the NVMe driver in block 702 may include the inline cryptographic module.

In block 704, the inline cryptographic device may generate hash values for the one or more buffer addresses. To generate the hash values, the inline cryptographic device may retrieve information from a security context structure (e.g., security context structure 302 in FIGS. 3 and 6), including information associated with an NVMe security ID received from the NVMe driver, such as a hash algorithm, one or more hash key slots for retrieving one or more hash keys from a hash key storage structure, etc. The inline cryptographic device may use the hash algorithm with the one or more hash keys, retrieved using the one or more hash key slots, to generate a hash value of a buffer address, an NVMe security ID, and a sector offset. In some examples, the inline cryptographic device generating the hash values for the one or more buffer addresses in block 704 may include the inline cryptographic module, a hash module (e.g., hash module 600 in FIG. 6), and/or a hash generation module (e.g., hash generation module 602 in FIG. 6).

In block 706, the inline cryptographic device may provide a hash value to an NVMe device (e.g., NVMe device 214 in FIG. 2) for inclusion in a device hint. The inline cryptographic device may provide the hash value to the NVMe device via a device interface (e.g., storage memory interface 20 in FIG. 1, PCIe controller 212 in FIG. 2), for inclusion in a device hint to be sent back to the inline cryptographic device for an NVMe transaction. The hash sent to the NVMe device may be sent in association with other information, such as part of a device hint that may be returned by the NVMe device for an NVMe transaction. The device hint sent to the NVMe device may include the hash, an NVMe security ID, a buffer address, a sector offset, a cookie, predefined text or data, and/or other information that may help in processing the device hint. In some examples, the inline cryptographic device providing the hash value to the NVMe device in block 706 may include the inline cryptographic module.

In the method 700b, in block 710, the inline cryptographic device may receive an NVMe transaction and a device hint from the NVMe device. The NVMe transaction and the device hint may be received via the device interface. In some examples, the inline cryptographic device receiving the NVMe transaction and the device hint from the NVMe device in block 710 may include the inline cryptographic module, the hash module, and/or the hash generation module.

In block 712, the inline cryptographic device may generate a hash value using the information from the device hint. The inline cryptographic device may process the device hint and extract information from the device hint, including an NVMe security ID, a buffer address, a sector offset for the NVMe transaction, a cookie, predefined text or data, and/or other information that may help in processing the device hint. The inline cryptographic device may also retrieve security context information from the security context structure to generate the hash value for the NVMe transaction. The information retrieved from the security context structure 302 may be information associated with the NVMe security ID of the device hint, and may include a hash algorithm, one or more hash key slots for retrieving one or more hash keys from a hash key storage structure, etc. The inline cryptographic device may use the hash algorithm with the one or more hash keys, retrieved using the one or more hash key slots, to generate the hash value of the buffer address, the NVMe security ID, and the sector offset. In some examples, the inline cryptographic device generating the hash value using the information from the device hint in block 712 may include the inline cryptographic module, the hash module, and/or the hash generation module.

In optional block 714, the inline cryptographic device may compare the hash value generated using information from the device hint and a validation value. For example, part of the information extracted from the device hint may include a hash value that was previously generated by the inline cryptographic device and sent to the NVMe device in blocks 704 and 706 of the method 700a, with reference to FIG. 7A. The hash value generated using information from the device hint and a hash value from the device hint may be compared to evaluate integrity of the device hint for the NVMe transactions. As another example, the hash value generated using information from the device hint and a predetermined value may be compared to evaluate integrity of the device hint for the NVMe transactions. In some examples, the inline cryptographic device comparing the hash value generated using information from the device hint and the validation value in optional block 714 may include the inline cryptographic module, the hash module, and/or a hash validation module (e.g., hash validation module 604 in FIG. 6).

In determination block 716, the inline cryptographic device may determine whether the device hint is valid. For example, based on the comparison of the values in optional block 714, the inline cryptographic device may determine that the hash values are the same or different. Any known or proprietary means for validating a hash value may be used to validate the device hint. In some examples, the inline cryptographic device determining whether the device hint is valid in determination block 716 may include the inline cryptographic module, the hash module, and/or the hash validation module.

In response to determining that the device hint is not valid (i.e., determination block 716=“No”), the inline cryptographic device may receive an NVMe transaction and a device hint from the NVMe device in block 710. In response to determining that the device hint is valid (i.e., determination block 716=“Yes”), the inline cryptographic device may configure a buffer address lookup structure (e.g., buffer address lookup structure 300 in FIGS. 3 and 6) using information from the device hint for the NVMe transaction in block 718. The inline cryptographic device may process the device hint, extracting the data for populating the buffer address lookup structure and store the data as the buffer address lookup structure. In some examples, the inline cryptographic device configuring the buffer address lookup structure using the information from the device hint for the NVMe transaction in block 718 may include the inline cryptographic module.

The inline cryptographic device may implement the operations in blocks 408-416 as described herein for the like numbered blocks of the method 400 with reference to FIG. 4. In some examples, the inline cryptographic device implementing blocks 408-416 may include the inline cryptographic device, an encryption module (e.g., encryption module 304 in FIG. 3), and/or a decryption module (e.g., decryption module 306 in FIG. 3).

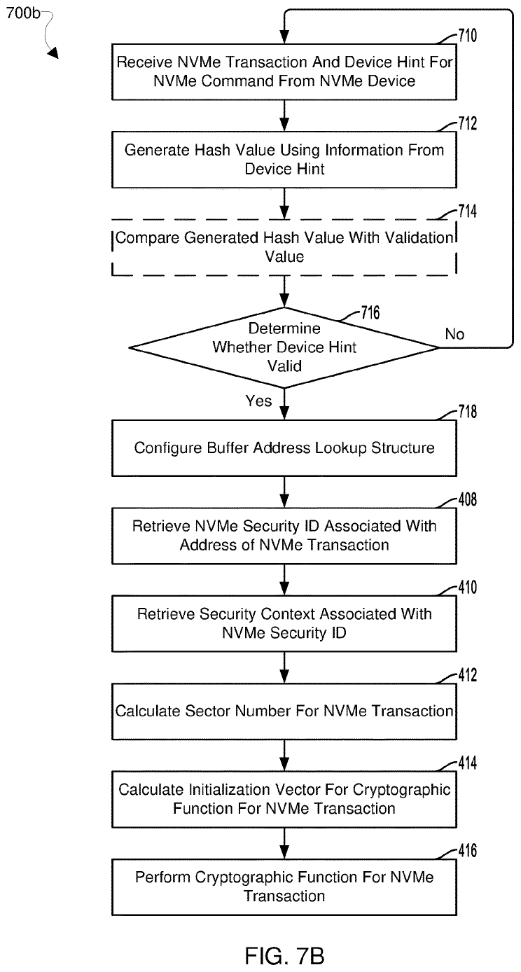

Various embodiments (including, but not limited to, embodiments described above with reference to FIGS. 1-7B) may be implemented in a wide variety of computing systems including mobile computing devices, an example of which suitable for use with the various embodiments is illustrated in FIG. 8. The mobile computing device 800 may include a processor 802 coupled to a touchscreen controller 804 and an internal memory 806. The processor 802 may be one or more multicore integrated circuits designated for general or specific processing tasks. The internal memory 806 may be volatile or non-volatile memory and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 804 and the processor 802 may also be coupled to a touchscreen panel 812, such as a resistive-sensing touchscreen, capacitive-sensing touchscreen, infrared sensing touchscreen, etc. Additionally, the display of the mobile computing device 800 need not have touch screen capability.

The mobile computing device 800 may have one or more radio signal transceivers 808 (e.g., Peanut, Bluetooth, ZigBee, Wi-Fi, RF radio) and antennae 810, for sending and receiving communications, coupled to each other and/or to the processor 802. The transceivers 808 and antennae 810 may be used with the above-mentioned circuitry to implement the various wireless transmission protocol stacks and interfaces. The mobile computing device 800 may include a cellular network wireless modem chip 816 that enables communication via a cellular network and is coupled to the processor.

The mobile computing device 800 may include a peripheral device connection interface 818 coupled to the processor 802. The peripheral device connection interface 818 may be singularly configured to accept one type of connection or may be configured to accept various types of physical and communication connections, common or proprietary, such as Universal Serial Bus (USB), Fire Wire, Thunderbolt, or PCIe. The peripheral device connection interface 818 may also be coupled to a similarly configured peripheral device connection port (not shown).

The mobile computing device 800 may also include speakers 814 for providing audio outputs. The mobile computing device 800 may also include a housing 820, constructed of a plastic, metal, or a combination of materials, for containing all or some of the components described herein. The mobile computing device 800 may include a power source 822 coupled to the processor 802, such as a disposable or rechargeable battery. The rechargeable battery may also be coupled to the peripheral device connection port to receive a charging current from a source external to the mobile computing device 800. The mobile computing device 800 may also include a physical button 824 for receiving user inputs. The mobile computing device 800 may also include a power button 826 for turning the mobile computing device 800 on and off.

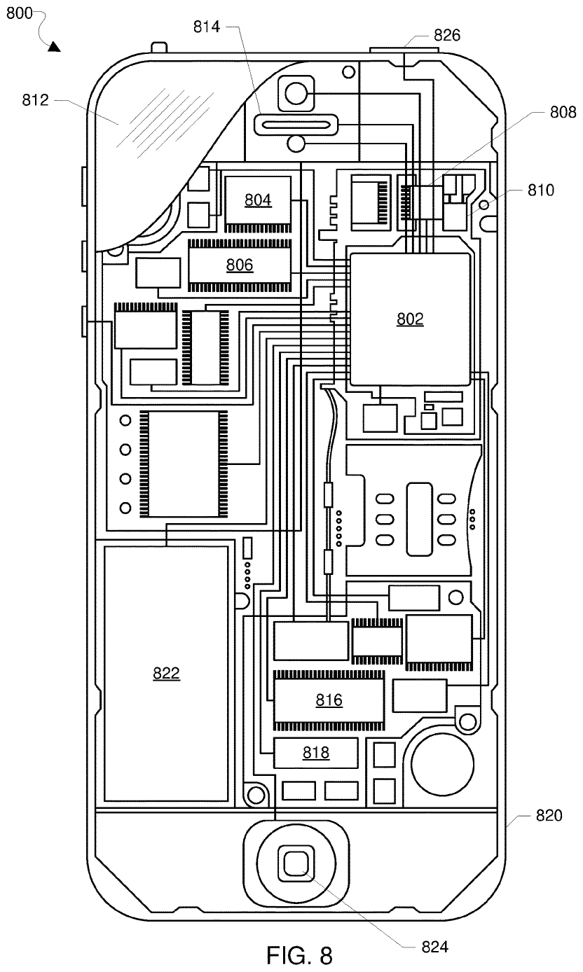

The various embodiments (including, but not limited to, embodiments described above with reference to FIGS. 1-7B) may be implemented in a wide variety of computing systems including a laptop computer 900 an example of which is illustrated in FIG. 9. Many laptop computers include a touchpad touch surface 917 that serves as the computer's pointing device, and thus may receive drag, scroll, and flick gestures similar to those implemented on computing devices equipped with a touch screen display and described above. A laptop computer 900 will typically include a processor 902 coupled to volatile memory 912 and a large capacity nonvolatile memory, such as a disk drive 913 of Flash memory. Additionally, the computer 900 may have one or more antenna 908 for sending and receiving electromagnetic radiation that may be connected to a wireless data link and/or cellular telephone transceiver 916 coupled to the processor 902. The computer 900 may also include a floppy disc drive 914 and a compact disc (CD) drive 915 coupled to the processor 902. In a notebook configuration, the computer housing includes the touchpad 917, the keyboard 918, and the display 919 all coupled to the processor 902. Other configurations of the computing device may include a computer mouse or trackball coupled to the processor (e.g., via a USB input) as are well known, which may also be used in conjunction with the various embodiments.

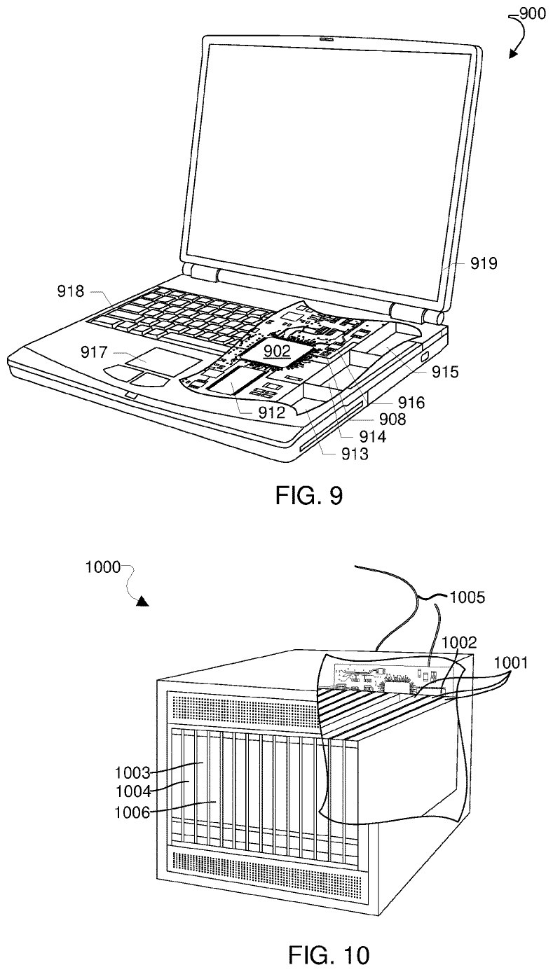

The various embodiments (including, but not limited to, embodiments described above with reference to FIGS. 1-7B) may also be implemented in fixed computing systems, such as any of a variety of commercially available servers. An example server 1000 is illustrated in FIG. 10. Such a server 1000 typically includes one or more multicore processor assemblies 1001 coupled to volatile memory 1002 and a large capacity nonvolatile memory, such as a disk drive 1004. As illustrated in FIG. 10, multicore processor assemblies 1001 may be added to the server 1000 by inserting them into the racks of the assembly. The server 1000 may also include a floppy disc drive, compact disc (CD) or digital versatile disc (DVD) disc drive 1006 coupled to the processor 1001. The server 1000 may also include network access ports 1003 coupled to the multicore processor assemblies 1001 for establishing network interface connections with a network 1005, such as a local area network coupled to other broadcast system computers and servers, the Internet, the public switched telephone network, and/or a cellular data network (e.g., CDMA, TDMA, GSM, PCS, 3G, 4G, 5G, LTE, or any other type of cellular data network).

Computer program code or “program code” for execution on a programmable processor for carrying out operations of the various embodiments may be written in a high-level programming language such as C, C++, C#, Smalltalk, Java, Javascript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Implementation examples are described in the following paragraphs. While some of the following implementation examples are described in terms of example systems, devices, or methods, further example implementations may include: the example systems or devices discussed in the following paragraphs implemented as a method executing operations of the example systems or devices, the example systems, devices, or methods discussed in the following paragraphs implemented by a computing device comprising an inline cryptographic module configured to perform operations of the example systems, devices, or methods; the example systems, devices, or methods discussed in the following paragraphs implemented by a computing device comprising a processing device configured with processing device-executable instructions to perform operations of the example systems, devices, or methods; a computing device including means for performing functions of the example systems, devices, or methods; and the example systems, devices, or methods discussed in the following paragraphs implemented as a non-transitory processor-readable storage medium having stored thereon processor-executable instructions configured to cause a processor of a computing device to perform the operations of the example systems, devices, or methods.
Example 1. A method implemented in an inline cryptographic module of a system on chip (SoC) for a nonvolatile memory express (NVMe) device, including storing data buffer addresses for NVMe commands and NVMe security identifiers for the NVMe commands in association with each other, in which the NVMe security identifiers include NVMe command submission queue identifiers and NVMe command identifiers for the NVMe commands, storing the NVMe security identifiers and security contexts for the NVMe commands in association with each other, retrieving a security context for an NVMe command based on an association of a data buffer address for the NVMe command with an NVMe security identifier of the NVMe command and an association of the NVMe security identifier with a security context for the NVMe command, and implementing a cryptographic function for data of the NVMe command using information of the security context for the NVMe command.
Example 2. The method of example 1, further including configuring a structure for storing the data buffer addresses for the NVMe commands and the NVMe security identifiers for the NVMe commands in association with each other by an NVMe driver at the inline cryptographic module using information of the NVMe command, and configuring a structure for storing the NVMe security identifiers and the security contexts for the NVMe commands in association with each other by the NVMe driver at the inline cryptographic module using information of the NVMe command.
Example 3. The method of example 1, further including receiving the NVMe command from an NVMe driver, configuring a structure for storing the data buffer addresses for the NVMe commands and the NVMe security identifiers for the NVMe commands in association with each other using information of the NVMe command, and configuring a structure for storing the NVMe security identifiers and the security contexts for the NVMe commands in association with each other using information of the NVMe command.
Example 4. The method of any of examples 1-3, further including updating an NVMe command submission queue tail pointer with a doorbell register address.
Example 5. The method of any of examples 1-4, further including generating a hash value for the NVMe command using information of the security context for the NVMe commands based on the association of the data buffer address for the NVMe command with the NVMe security identifier of the NVMe command and the association of the NVMe security identifier with the security context for the NVMe command, in which the hash value is for inclusion by an NVMe device in a device hint for the NVMe command.
Example 6. The method of any of examples 1-5, further including receiving a device hint for the NVMe command including a hash value of the NVMe command from an NVMe device, and configuring a structure for storing the data buffer addresses for the NVMe commands and the NVMe security identifiers for the NVMe commands in association with each other using information of the device hint for the NVMe command.
Example 7. The method of example 6, further including validating the device hint for the NVMe command using the hash value, in which configuring the structure for storing the data buffer addresses for the NVMe commands and the NVMe security identifiers for the NVMe commands in association with each other using information of the device hint for the NVMe command includes configuring the structure for storing the data buffer addresses for the NVMe commands and the NVMe security identifiers for the NVMe commands in association with each other using information of the device hint for the NVMe command in response to determining that the device hint is valid.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein but is to be accorded the widest scope consistent with the following claims and the principles and novel features disclosed herein.

1. A method implemented in an inline cryptographic module of a system on chip (SoC) for a nonvolatile memory express (NVMe) device, comprising:
storing data buffer addresses for NVMe commands and NVMe security identifiers for the NVMe commands in association with each other, wherein the NVMe security identifiers include NVMe command submission queue identifiers and NVMe command identifiers for the NVMe commands;
storing the NVMe security identifiers and security contexts for the NVMe commands in association with each other;
retrieving a security context for an NVMe command based on an association of a data buffer address for the NVMe command with an NVMe security identifier of the NVMe command and an association of the NVMe security identifier with a security context for the NVMe command; and
implementing a cryptographic function for data of the NVMe command using information of the security context for the NVMe command.

2. The method of claim 1, further comprising:
configuring a structure for storing the data buffer addresses for the NVMe commands and the NVMe security identifiers for the NVMe commands in association with each other by an NVMe driver at the inline cryptographic module using information of the NVMe command; and configuring a structure for storing the NVMe security identifiers and the security contexts for the NVMe commands in association with each other by the NVMe driver at the inline cryptographic module using information of the NVMe command.

3. The method of claim 1, further comprising:
receiving the NVMe command from an NVMe driver;
configuring a structure for storing the data buffer addresses for the NVMe commands and the NVMe security identifiers for the NVMe commands in association with each other using information of the NVMe command; and
configuring a structure for storing the NVMe security identifiers and the security contexts for the NVMe commands in association with each other using information of the NVMe command.

4. The method of claim 1, further comprising updating an NVMe command submission queue tail pointer with a doorbell register address.

5. The method of claim 1, further comprising generating a hash value for the NVMe command using information of the security context for the NVMe commands based on the association of the data buffer address for the NVMe command with the NVMe security identifier of the NVMe command and the association of the NVMe security identifier with the security context for the NVMe command, wherein the hash value is for inclusion by an NVMe device in a device hint for the NVMe command.

6. The method of claim 1, further comprising:
receiving a device hint for the NVMe command including a hash value of the NVMe command from an NVMe device; and
configuring a structure for storing the data buffer addresses for the NVMe commands and the NVMe security identifiers for the NVMe commands in association with each other using information of the device hint for the NVMe command.

7. The method of claim 6, further comprising validating the device hint for the NVMe command using the hash value,
wherein configuring the structure for storing the data buffer addresses for the NVMe commands and the NVMe security identifiers for the NVMe commands in association with each other using information of the device hint for the NVMe command comprises configuring the structure for storing the data buffer addresses for the NVMe commands and the NVMe security identifiers for the NVMe commands in association with each other using information of the device hint for the NVMe command in response to determining that the device hint is valid.

8. A computing device, comprising:
an inline cryptographic module of a system on chip (SoC) for a nonvolatile memory express (NVMe) device, the inline cryptographic module configured to:
store data buffer addresses for NVMe commands and NVMe security identifiers for the NVMe commands in association with each other, wherein the NVMe security identifiers include NVMe command submission queue identifiers and NVMe command identifiers for the NVMe commands;
store the NVMe security identifiers and security contexts for the NVMe commands in association with each other;
retrieve a security context for an NVMe command based on an association of a data buffer address for the NVMe command with an NVMe security identifier of the NVMe command and an association of the NVMe security identifier with a security context for the NVMe command; and implement a cryptographic function for data of the NVMe command using information of the security context for the NVMe command.

9. The computing device of claim 8, wherein the cryptographic module is further configured to:
configure a structure for storing the data buffer addresses for the NVMe commands and the NVMe security identifiers for the NVMe commands in association with each other by an NVMe driver at the inline cryptographic module using information of the NVMe command; and configure a structure for storing the NVMe security identifiers and the security contexts for the NVMe commands in association with each other by the NVMe driver at the inline cryptographic module using information of the NVMe command.

10. The computing device of claim 8, wherein the cryptographic module is further configured to:
receive the NVMe command from an NVMe driver;
configure a structure for storing the data buffer addresses for the NVMe commands and the NVMe security identifiers for the NVMe commands in association with each other using information of the NVMe command; and
configure a structure for storing the NVMe security identifiers and the security contexts for the NVMe commands in association with each other using information of the NVMe command.

11. The computing device of claim 8, wherein the cryptographic module is further configured to update an NVMe command submission queue tail pointer with a doorbell register address.

12. The computing device of claim 8, wherein the cryptographic module is further configured to generate a hash value for the NVMe command using information of the security context for the NVMe commands based on the association of the data buffer address for the NVMe command with the NVMe security identifier of the NVMe command and the association of the NVMe security identifier with the security context for the NVMe command, wherein the hash value is for inclusion by an NVMe device in a device hint for the NVMe command.

13. The computing device of claim 8, wherein the cryptographic module is further configured to:
receive a device hint for the NVMe command including a hash value of the NVMe command from an NVMe device; and
configure a structure for storing the data buffer addresses for the NVMe commands and the NVMe security identifiers for the NVMe commands in association with each other using information of the device hint for the NVMe command.

14. The computing device of claim 13, wherein the cryptographic module is further configured to:
validate the device hint for the NVMe command using the hash value; and configure the structure for storing the data buffer addresses for the NVMe commands and the NVMe security identifiers for the NVMe commands in association with each other using information of the device hint for the NVMe command in response to determining that the device hint is valid.

15. A computing device, comprising:
means for storing data buffer addresses for nonvolatile memory express (NVMe) commands and NVMe security identifiers for the NVMe commands in association with each other, wherein the NVMe security identifiers include NVMe command submission queue identifiers and NVMe command identifiers for the NVMe commands;
means for storing the NVMe security identifiers and security contexts for the NVMe commands in association with each other;
means for retrieving a security context for an NVMe command based on an association of a data buffer address for the NVMe command with an NVMe security identifier of the NVMe command and an association of the NVMe security identifier with a security context for the NVMe command; and
means for implementing a cryptographic function for data of the NVMe command using information of the security context for the NVMe command.

16. The computing device of claim 15, further comprising:
means for configuring a structure for storing the data buffer addresses for the NVMe commands and the NVMe security identifiers for the NVMe commands in association with each other by an NVMe driver at the inline cryptographic module using information of the NVMe command; and
means for configuring a structure for storing the NVMe security identifiers and the security contexts for the NVMe commands in association with each other by the NVMe driver at the inline cryptographic module using information of the NVMe command.

17. The computing device of claim 15, further comprising:
means for receiving the NVMe command from an NVMe driver;
means for configuring a structure for storing the data buffer addresses for the NVMe commands and the NVMe security identifiers for the NVMe commands in association with each other using information of the NVMe command; and means for configuring a structure for storing the NVMe security identifiers and the security contexts for the NVMe commands in association with each other using information of the NVMe command.

18. The computing device of claim 15, further comprising means for updating an NVMe command submission queue tail pointer with a doorbell register address.

19. The computing device of claim 15, further comprising means for generating a hash value for the NVMe command using information of the security context for the NVMe commands based on the association of the data buffer address for the NVMe command with the NVMe security identifier of the NVMe command and the association of the NVMe security identifier with the security context for the NVMe command, wherein the first value is for inclusion by an NVMe device in a device hint for the NVMe command.

20. The computing device of claim 15, further comprising:
means for receiving a device hint for the NVMe command including a first hash value of the NVMe command from an NVMe device; and
means for configuring a structure for storing the data buffer addresses for the NVMe commands and the NVMe security identifiers for the NVMe commands in association with each other using information of the device hint for the NVMe command.

21-28. (canceled)
